(19) United States
(12) Patent Application Publication
(10) Pub. No.: US 2003/0126620 A1
(43) Pub. Date: Jul. 3, 2003

(54) Multimedia display system using display unit of portable computer, and signal receiver for television, radio, and wireless telephone

(76) Inventor: Toshio Hayakawa, Los Angeles, CA (US)

Correspondence Address: Toshio Hayakawa, 10021 Tabor Street #311, Los Angeles, CA, 90034, US

(21) Appl. No.: 10/100,643

(22) Filed: Mar. 19, 2002

Related U.S. Application Data
(60) Provisional application No. 60/345,926, filed on Dec. 31, 2001.

(51) Int. Cl. H04N 7/16; H04N 7/20; H04N 7/173; H04N 7/00; H04N 11/00

(52) U.S. Cl. 725/133; 725/141; 348/552; 725/62; 725/68

(57) ABSTRACT

A flat panel display unit (210), detachable or non-detachable type, of a portable computer (60) is used to display video and audio multimedia information generated by televisions, digital radio, cellular telephones, portable computers, and all other peripheral devices. By connecting the newly invented receiver (200) to the display unit (210) of the portable computer (60), a user can watch television programs, listen to radio, or browse Internet at any time and at any locations.

### BACKGROUND—CROSS REFERENCE TO RELATED APPLICATIONS

This application claims the benefit of Provisional Patent Application Ser. No. 60/345,926 filed on Dec. 31, 2001.

### BACKGROUND—FIELD OF INVENTION

This invention relates generally to a multimedia entertainment display system using a liquid crystal display of a portable computer system.

### BACKGROUND—OTHER REFERENCES

“Display Technologies” by Patrick Dunn of Dell Corporation, July 1999. Published by Dell Corporation.

“Basic Television and Video Systems Sixth Edition” by Grob Herndon Glencoe. Published by McGraw-Hill

“HDTV High-Definition Television” by Stan Prentiss. Published by TAB BOOKS Inc.

“Practical ANTENNA Handbook Second Edition” by Joseph J. Carr. Published by TAB BOOKS Inc.

“Guide to Satellite Technology” by John A. Ross. Published by Prompt Publication

“The Radio Station, Second Edition” by Michael C. Keith/Joseph M. Published by Focal Press.

“Microwaves and Wireless Simplified” by Thomas S. Laverghetta. Published by Artech House.

“Microwave Engineering and Systems Application” by Edward A. Wolff/Roger Kaul. Published by John Wiley & Sons

### BACKGROUND—DESCRIPTION OF PRIOR ART

A portable computer having an active-matrix liquid-crystal display (AMLCD) is very popular according to the white paper written by Patrick Dunn of Dell Corporation, which is available on the web site of Dell Corporation. The processing power of CPU in a portable computer is also getting higher and higher in each year as Intel and AMD corporation races each other to come up with faster and better CPU by squeezing more transistors in limited physical space. Despite of these advanced features, average consumers prefer more functions on those high performance portable computers.

In the past, there are many inventions are granted for the portable computer having a detachable or non-detachable display unit. However, none of these patents are related to this invention. Furthermore, true values for those inventions are not passed onto consumers due to the luck of true usable devices.

### OBJECTS AND ADVANTAGES

Accordingly, besides the objects and advantages of the detachable and non-detachable display units described in this patent, several objects and advantages of the present inventions are:

(a) to provide a method to display television-broadcasting programs using detachable or non-detachable AMLCD or liquid crystal display (LCD) unit at any place;

(b) to provide a method to display a plurality of wireless Internet web contents when used with an Internet browser capability cellular telephone;

(c) to provide a method to display music video that a digital radio station broadcasts digital audio and video signals so that a user can listen and watch video music; and

(d) to provide a method to watch television, and listen radio while a user works on a portable computer at any place and any time.

These and further objects and advantages will be apparent to those skilled in the art in conjunction with drawings and the detailed description of the preferred embodiment set from below.

### SUMMARY OF THE INVENTION

An AMLCD or LCD unit of a portable computer is attached to the main body using mechanical hinges. To use the portable computer, a user opens the display unit by unlatching it from the main body. Then, the user operates word processing software or browses Internet using dial-up telephone line or local area network.

The display unit is one of the expensive components in its portable computer. Though prices of portable computers are coming down dramatically. However, consumers are not getting enough benefit using such expensive portable computers. The purpose of this invention is to increase the benefit and spread high cost component to wider capability scope so that consumers can take advantage of buying one portable computer with a small feature for the big advantages and features. One way to achieve this is to use it as a multi-function display unit. Lately, sales of high definition television (HDTV) and digital television (DTV) have been risen at many electronic stores. However, since the cost of making huge plasma display unit is so high, and consequently, implementing and adapting HDTV program into consumer are hampered. On the other hand, display units of portable computers are getting less cost to produce since millions of units are manufactured in each year. Hence, this invention can take advantage of such trend by using a display unit of the portable computer as entertainment display device. This is achievable by displaying multimedia, such as video or music video with audio, and uses it as a screen for television set. Hence, using the display unit as the television monitor and other monitoring devices will enhance, and return the economical benefit to consumers.

Another advantage using a removed display unit is to use as monitoring device for an Internet browser capable cellular telephone. Lately, much more advanced features in cellular telephones are equipped, and provided by many of cellular telephone manufactures such as web browsing capability and E-mail application. By connecting the display units with these cellular telephones can browse Internet very easily rather than using small LCD screens currently used in all cellular telephones.

Yet, another advantage is to use it for a digital radio receiver. Today's modern digital radio broadcasting stations can transmit digital music and video picture. Viewers can watch the music video and listen to the music, as many consumers view music videos on their televisions.

Another advantage is to use it together with a digital video display (DVD) player since the connector on this display unit has the standard signal interface used in the video industry.

These ideas above mentioned are just few good and beneficial to consumers who are thinking of buying the newly implemented and designed portable computers. Buying the portable computer with this newly invented function will justify the buying cost because consumers don't need to buy both a TV set and a portable computer at the same time. Furthermore, when broadcasting companies are ready to broadcast HDTV fully, this newly invented detachable or non-detachable display unit can use as HDTV monitor, which is different from the conventional analog television monitor.

### BRIEF DESCRIPTION OF FIGURES

FIG. 1 illustrates the diagram of the detached display unit connected with the receiver for television, radio, cellular telephone, and satellite systems.

FIG. 2 illustrates the detail functional diagram of the receiver.

FIG. 3 illustrates the diagram how the detachable unit and the receiver connect with the television and radio stations, and the satellite station.

FIG. 4 illustrates the diagram how the detachable unit and the receiver connect with the cellular telephone system.

FIG. 5 illustrates a method how a conventional portable computer with non-detachable display unit connects to the receiver for receiving signals transmitted by the television, the radio, and the satellite stations.

FIG. 6 illustrates a toggle circuitry using a plurality of multiplexer integrated chips used in this newly invented portable computer with non-detachable display unit.

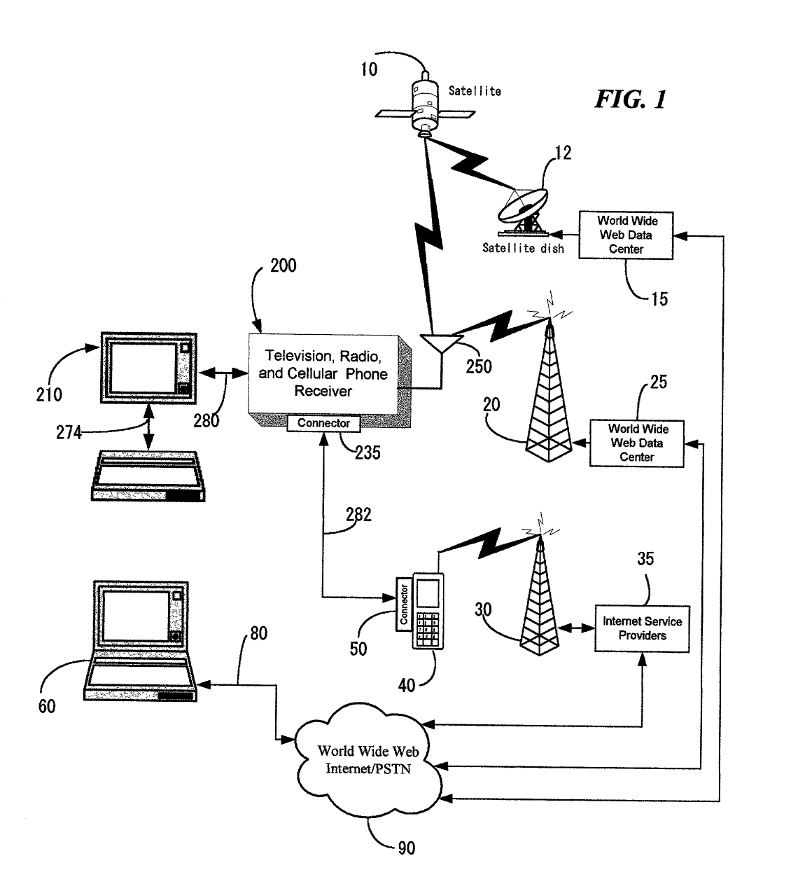

### DETAILED DESCRIPTION OF THE PREFERRED EMBODIMENT—FIGS. 1 to 6

FIG. 1 illustrates how this newly invented detachable display unit 210 is connected with a newly invented receiver 200. A conventional portable computer 60 has a main body and a display unit. A plurality of cable 274 connects the main body and the display unit 210 internally. Normally, users do not see these cables since they are housed in between the display unit 210 and the main body 60 internally, which is the advantage of the portable computer 60. Having such mechanism and flexible cables enable to close the display unit 210 when the portable computer 60 is not used. For using the detachable display unit 210, after it is detached from the main body 60 by disconnecting the cable 274 and the mechanical hinges, the display unit 210 connects to the receiver 200. There is a signal cable 280, which connects the display unit 210 and the receiver 200. The receiver 200 can receive signals from a satellite station 10, television or radio tower stations 20, and a cellular telephone tower 30 by having an appropriate antenna type 250 for each station. Then the receiver 200 processes the signals transmitted by these stations and sends to the display unit 210. The detached display unit 210 works as the independent display unit for the television, the music video, and the radio programs, and viewers can watch the programs at any places.

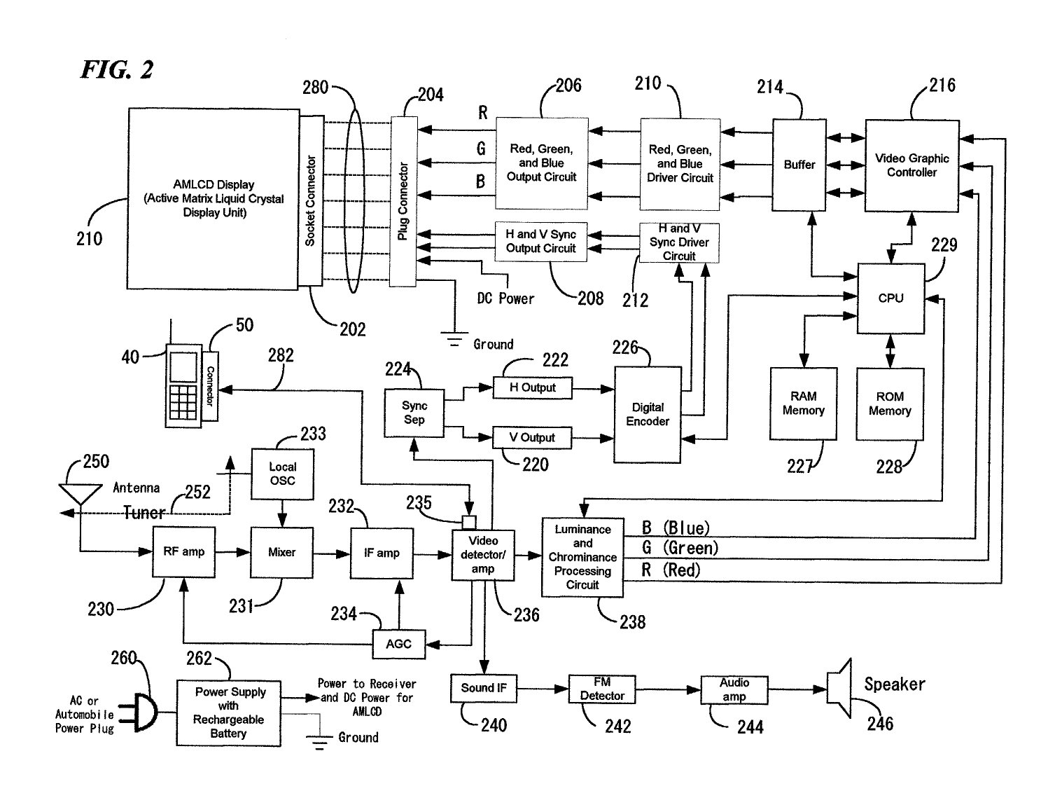

The conventional portable computer 60 connects to the Internet 90 to check broadcasting programs at each station's World Wide Web data center 15 and 25 by either dial-up or leased telephone line. Once a user finds favorite programs in the data center that the user wants to see, then turn off the conventional portable computer 60. Then, the user disconnects the display unit 210 from the main body 60, and connects it to the receiver 200. Viewing and selection of preferred programs transmitted by a broadcast station is achieved by adjusting the channel selector, which is the integral part of local oscillator (OSC) 233 and the dashed arrow line 252 in FIG. 2.

The display unit 210 works for the cellular telephone 40 since it has capability to surf Internet. Instead of using a small LCD on the device 40, a telephone user can browse Internet using the display unit 210 and the receiver 200 by using an external signal cable 282. Once it is connected then the user browses the Internet 90 by using keypads on the cellular telephone 40 just as the user normally does using the LCD display of the cellular telephones. Instead of having web contents displayed on the LCD, the web contents are displayed on the display unit 210.

FIG. 2 illustrates detail functional diagram about a receiver 200. This is a typical superhetrodyne receiver block diagram. There are two input signal interfaces, and one output signal interface.

The first input signal, which consists of audio and video signals, is fed through an antenna 250 to a radio frequency amplifier (RF amp) 230. The antenna 250 will have different types depending on signal sources from a home television antenna to a satellite dish antenna. The RF amp 230 and the tuner 252, which are the integral part of the local OSC 233 and the dashed arrow line in FIG. 2, select broadcasting stations that viewers want to watch.

The second input signal for a cellar telephone signal is fed to a video detector/amplifier 236 via an external connector 235. A signal cable 282 connects the cellular telephone and the receiver 200 using the external connectors 50 and 235. The signal from the cellular telephone 40 is non-modulated signal, and it is not required to go through the RF 230 and an IF amplifier 232.

Since the cellular telephone 40 does not have full graphic display capability due to the physical size limitation of the LCD, an embedded browser software, such as Netscape or Microsoft Internet Explore software stored in a plurality of the ROM memory 228, can provide such capability. When the receiver 200 receives the full web contents via the cellular telephone 40, the CPU 229 detects web contents. If some applications are to be run on the receiver 200 such as Java application, then a CPU 229 can run Java application software, and so on.

Preferred channels defined by Federal Communication Commission (FCC) for both audio and video signal are selected by tuning right frequency of the local OSC 233 and the tuner 252. The tuner 252 tunes a correct frequency with incoming frequency signals from the antenna 250 and the local OSC 233 to detect a right career frequency for the broadcasting station.

The video detector 236 separates the received signals into a plurality of audio, synchronization, and video signals. The audio signal is fed to a second intermediate frequency (IF) 240 and then fed to a frequency modulation (FM) detector 242 to detect sound. Once small sound signal is detected then it is amplified using an audio amp 244, which feeds to a speaker 246 to generate audio sound.

When the synchronization signal is processed using a sync separator 224, the output result will have two signals. One for horizontal (H) and other is a vertical (V) sync signal. These signals are used together with the video signal to form correct pictures on the display unit 210. Since these signals are analog, they need to be converted for the AMLCD display unit 210. A digital encoder 226 does this process.

A video detector/amplifier 235 feeds the video signals to a plurality of luminance and chrominance processing circuitry 238. The luminance and chrominance circuitry 238 generates red, green, and blue signals, which are fed to a video graphic controller circuitry 216, and processed for the display unit 210.

The video graphic controller 216, a plurality of buffer 214, a plurality of red, green, and blue driver 210, and its output circuitry 206 are standard output video driver circuitry used for any digital display units, and are used in all personal computer graphic display cards.

A power supply 262 supplies power to the display unit 210 and the receiver 200 through the connectors 202 and 204. The display unit 210 requires several DC voltages to drive a plurality of pixels, a plurality of field effect transistors (FET), and other passive components. The power source is supplied normally by the portable computer 60. Since the display unit 210 is disconnected from the main unit 60, it requires separate power source to turn on the display unit 210. A plug 260 can connect to AC or automobile power source.

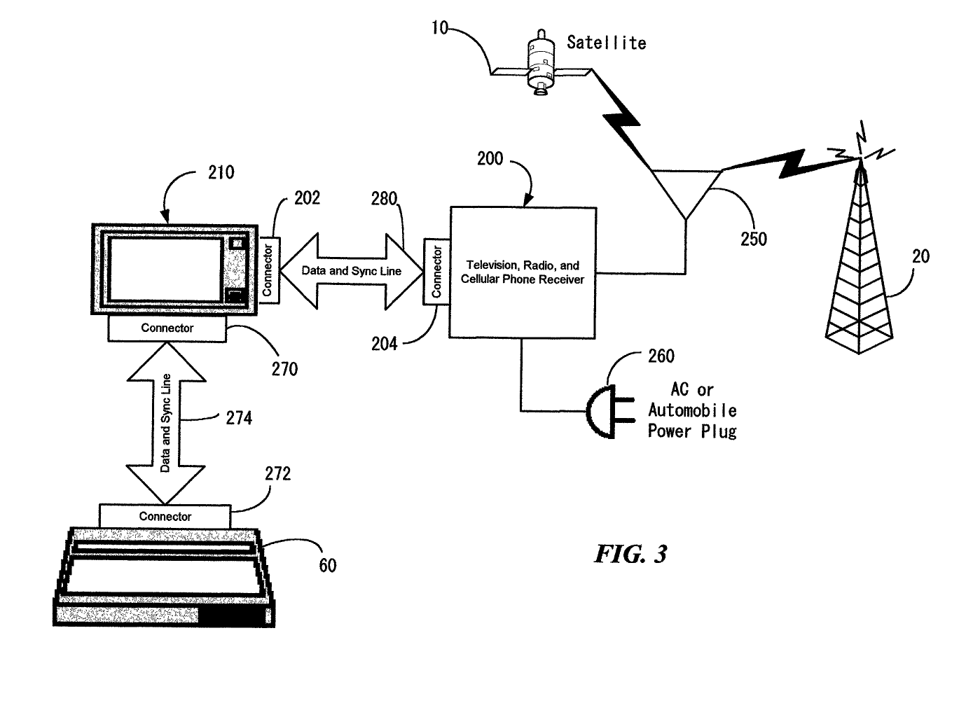

FIG. 3 illustrates a method of receiving signals from the satellite 10, and the radio and the television broadcasting stations 20 using the detached display unit 210 and the receiver 200. A different antenna 250 is required depending on types of signal sources. For receiving satellite broadcasting, a satellite dish antenna is used for the receiver 200 whereas for audio and television broadcastings, a regular indoor television antenna can be used.

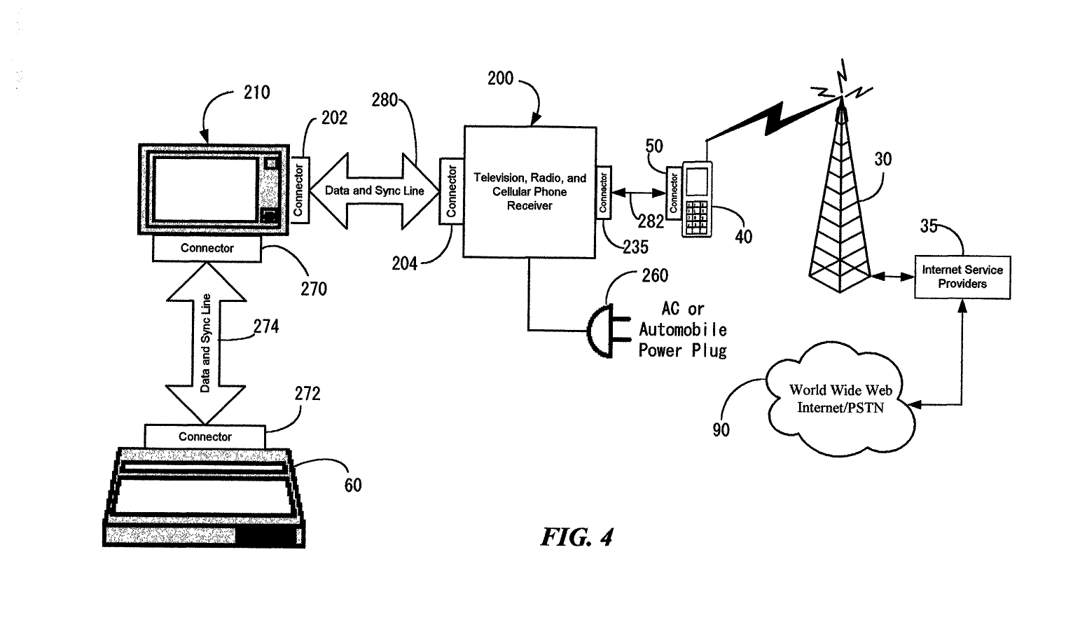

FIG. 4 illustrates a method of obtaining Internet web contents information using a cellular telephone 40 and the receiver 200. The current method to browse the Internet 90, provided by an Internet service provider (ISP) 35, is to use number keypads of the cellular telephone 40. Displaying graphical information on the current cellular telephone LCD 40 is limited by the physical size of the cellular telephone. Having and connecting the display unit 210 to the cellular telephone 40 enables the browsing capability. Furthermore, since the display unit 210 is detached from the main CPU unit, the separate power source 260 is required.

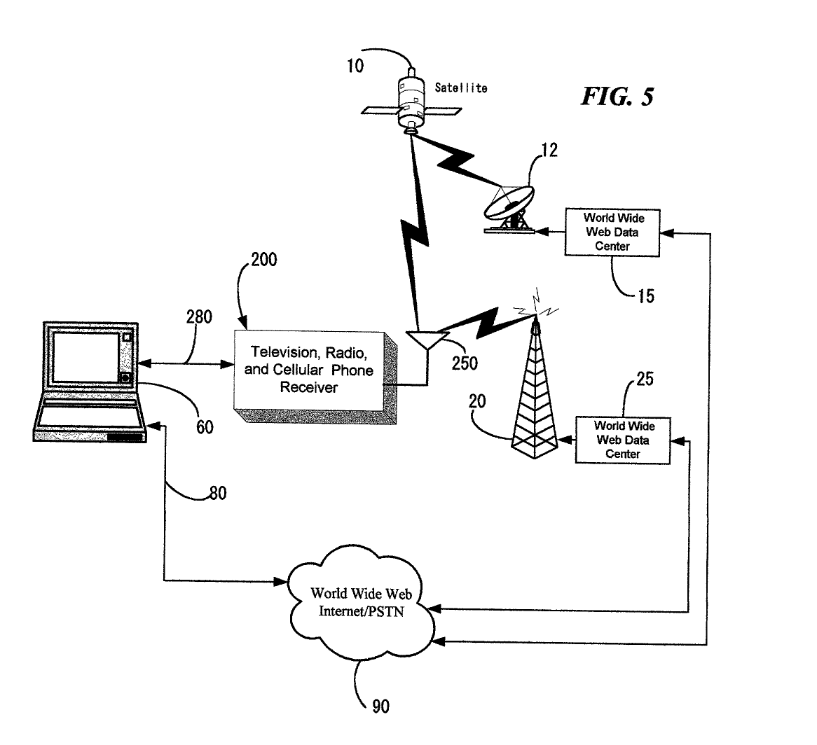

FIG. 5 illustrates how the conventional portable computer 60 is connected with the receiver 200 while a user uses the portable computer 60. Without detaching the display unit 210 of the conventional portable computer or turning off the power of the portable computer 60, the receiver 200 can plug right into the connector 202, in FIG. 2, of the display unit of the portable computer 60. The user can watch television or listen to radio while the operation of the compute work is uninterrupted by toggling predefined keys of the portable computer 60.

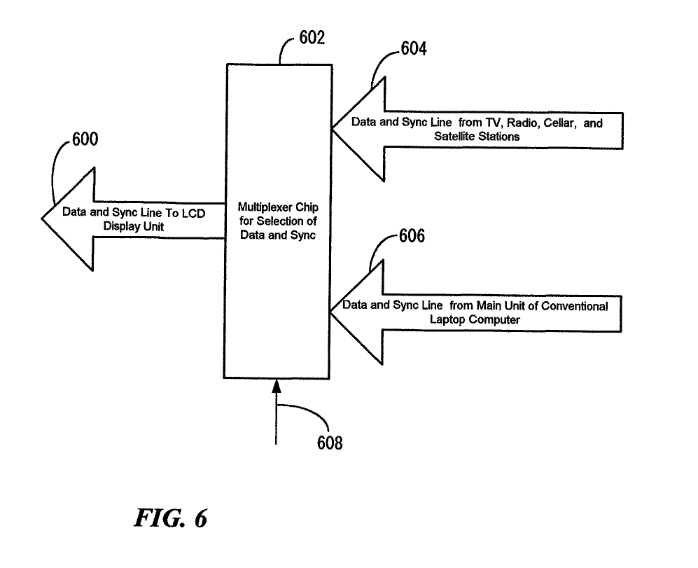

FIG. 6 illustrates an internal switching circuitry used when the receiver 200 and the conventional portable computer 60 connected, depicted in FIG. 5. The multiplex chip 602 receives a plurality of signals 604 and 606 from the receiver 200 and the main unit of the conventional portable computer 60 respectively. By combining couple of keys and pressing them enables the command line 608. The command depending which signal is present on the data and sync line 600 toggles the signal between the receiver 200 and the main unit of the portable computer 60.

### OPERATION—FIGS. 3, 4, 5

For using the conventional portable computer 60 with a detachable unit 210 is as follows: to watch desired programs of television or music video programs, first a user connects to the Internet 90 by using either dial-up or a digitally subscribed line (DSL) line to browse desired program, and its time schedule at each broadcast station. Once, all information is obtained using the Internet 90 then turn off the power of the main portable computer 60. Then the user disconnects the display unit 210 from a main unit 60. Once the display unit 210 is disconnected then connect the display unit 210 to a receiver 200 with a signal cable 280. Then select a desired channel by adjusting a tuner 252 of the receiver 200. Since the display monitor 210 and the receiver 200 are easily transportable, the user can see selected programs at any locations such as in a car, airplane, or any place in a house by just carrying the display unit 210 and the receiver 200.

To browse the Internet 90 using a cellular telephone 40, instead of connecting a satellite dish antenna or a regular indoor television antenna 250, simply a user needs to connect the signal cable 282 from the cellular telephone to the receiver 200 after ISP 35 is connected using regular web browser operation. At this moment, all web contents are viewed on the cellular telephone. Hence, by connecting the cellular telephone 40 with the receiver 200, the user can see better graphic contents than ones on LCD display unit of the cellular telephone, and send E-mail using any word processor software available on Internet to another users.

For using the conventional portable computer with non-detachable unit is as follows: a user simply connects the signal line cable 280 in FIG. 5 to a connector 202 while the power of the portable computer 60 is turned on. Install application software, which enables to select a plurality of key combinations, which provides a selection command, when those selected keys are pressed, that selects signal from the conventional portable computer or signal from the receiver 200. Using a couple of selected keys with the preloaded software, the user now can toggle the display unit which signal 604 or 606 can be shown.

### CONCLUSION, RAMIFICATIONS AND SCOOPS

Accordingly, the reader will see following advantages:

it provides enhancement of viewing capability using together with a cellular telephone since the viewing area of the display unit of a conventional portable computer is larger than that of the cellular telephone;

it provides more functions on an inactive component of a conventional portable computer when it is not used. This advantage returns the benefit of having such expensive component to consumers by using it as television and music video viewing unit;

it provides easy set up of viewing locations since the display unit and receiver unit are portable; and

it provides HDTV viewing capability when HDTV broadcast starts fully.

Although the description above contains many specifications, these should not be construed as limiting the scope of the invention but as merely providing illustrations of some of the presently preferred embodiments of this invention.

Further, the scope of the invention should be determined by the appended claims and their legal equivalents, rather than by the example given.

What is claimed is:

1. A multimedia display system comprising:
(a) a portable computer having a keyboard, a liquid crystal display unit, and a central processing unit,
wherein said display unit having a plurality of connectors;
wherein said central processing unit means having a plurality of connectors for disconnecting or connecting said liquid crystal display unit;
wherein said display unit means a flat panel display unit;
wherein said display unit means detachable means removing said display unit from said central processing unit, and said detached display is connectable again; and
wherein said connectors on said central processing unit means disconnecting or connecting said display unit from said central processing unit using a plurality of signal cables.
(b) a receiver device having television, radio, and cellular telephone voice and data signal reception circuit,
wherein said receiver device has a plurality of antenna for receiving signals from television, satellite, and radio stations means connecting satellite antenna for receiving satellite signal, television antenna for receiving television broadcasting signal, and radio antenna for receiving radio signal, and connecting said cellular telephone to said receiver device;
wherein said signal means having video, audio, and data information;
wherein said receiver device is connected to said multimedia display system means connecting said receiver device to said detached display unit using a plurality of signal cables and said connectors; and
wherein connecting said receiver device to said detached display unit means displaying a plurality of video on said detached display unit of said multimedia display system, and generating a plurality of said audio sound using a speaker on said receiver device.
(c) a cellular telephone having a connector means connecting said cellular telephone to said receiver device by using a plurality of signal cable,
wherein said cellular telephone connecting to said receiver device means displaying a plurality of Internet contents on said detached display unit of said multimedia display system.

2. A receiver device according to claim 1, in which said receiver device comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a wireless input circuitry to receive a plurality of signals transmitted from a plurality of cellular telephone stations,
wherein said wireless input circuitry consists of a video connector, and a video detector; and
wherein said signal means having a plurality of video, audio, and data information.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into said horizontal and said vertical sync synchronization signals.
(e) having a plurality of digital converter circuitry to process said signals into a flat panel display unit compatible signal format,
wherein said flat panel display unit compatible signal format means having a plurality of digital signal formats converted by using said digital converter circuitry; and
wherein said digital converter circuitry means converting analog signal into digital signal by using an encoder, a central processing unit, a plurality of read-only and random access memory, a plurality of video graphic controller, and a plurality of buffers.
(f) having a plurality of output circuitry to process means having output signals, which are signal compatible for said display unit,
wherein said output signal means processing said signals to amplify using a plurality of drivers and sync output circuitry.
(g) having a connector means connecting a cellular telephone to said video detector obtain a plurality of video, audio, and data signals, and
(h) having a power circuitry means supplying a plurality of power to said receiver device and said display unit,
wherein said power supply circuitry means converting alternate current power to direct current, and direct current to direct current to operate said receiver device and said display unit, and further, consist of a battery charger circuit to charge a plurality of batteries.

3. A multimedia display system comprising:
(a) a portable computer having a keyboard, a liquid crystal display unit, and a central processing unit,
wherein said display unit having a plurality of connectors;
wherein said display unit means a flat panel display unit; and
wherein said portable computer means having a plurality of signal input circuitry to toggle to receive a plurality of signals transmitted either from said central processing unit or said receiver device.
(b) a receiver device having television, radio, and cellular telephone voice and data signal reception circuit,
wherein said receiver device has a plurality of antenna for receiving signals from television, satellite, and radio stations means connecting satellite antenna for receiving satellite signal, television antenna for receiving television broadcasting signal, and radio antenna for receiving radio signal, and connecting said cellular telephone to said receiver device;
wherein said signal means having video, audio, and data information;
wherein said receiver device is connected to said multimedia display system means connecting said receiver device to said display unit using a plurality of signal cables and said connectors; and
wherein connecting said receiver device to said display unit means displaying a plurality of video on said display unit, and generating a plurality of audio sound using a speaker on said receiver device.

4. A receiver device according to claim 3, in which said receiver device comprising:
(a) having a plurality of input circuitry to receive a plurality of signal transmitted by a plurality of television and radio stations, and satellite broadcasting stations,
wherein said input circuitry consists of a radio frequency amplifier, a local oscillator, a mixer, an intermediate frequency amplifier, and a video detector;
wherein said video detector means separating said transmitted signal into a plurality of video, audio, and synchronization signals; and
wherein said signal means having a plurality of video, audio, and data information.
(b) having a wireless input circuitry to receive a plurality of signals transmitted from a plurality of cellular telephone stations,
wherein said wireless input circuitry consists of a video connector, and a video detector; and
wherein said signal means having a plurality of video, audio, and data information.
(c) having a plurality of signal processing circuitry to process said transmitted signal means reformatting a plurality of said transmitted signal format to another signal format means processing said transmitted signal using a plurality of signal processing circuitry,
wherein said signal processing circuitry means using a plurality of luminance and chrominance processing circuitry.
(d) having a plurality of synchronization separator circuitry means processing a plurality of said transmitted signal into a plurality of synchronization signals,
wherein said processing synchronization signal means processing into horizontal and vertical signal format using synchronization separator and its output circuitry; and
wherein said synchronization separator circuitry means separating said signal into horizontal and vertical sync synchronization signals.
(e) having a plurality of digital converter circuitry to process said signals into a flat panel display unit compatible signal format,
wherein said flat panel display unit compatible signal format means having a plurality of digital signal formats converted by using said digital converter circuitry; and
wherein said digital converter circuitry means converting analog signal into digital signal by using an encoder, a central processing unit, a plurality of read-only and random access memory, a plurality of video graphic controller, and a plurality of buffers.
(f) having a plurality of output circuitry to process means having output signals, which are signal compatible for said display unit,
wherein said output signal means processing said signals to amplify using a plurality of drivers and sync output circuitry.
(g) having a connector means connecting a cellular telephone to said video detector obtain a plurality of video, audio, and data signals, and
(h) having a power circuitry means supplying a plurality of power to said receiver device and said display unit,
wherein said power supply circuitry means converting alternate current power to direct current, and direct current to direct current to operate said receiver device and said display unit, and further, consist of a battery charger circuit to charge a plurality of batteries.

5. A portable computer according to claim 3, in which said portable computer further providing:
(a) a portable computer having a keyboard, a liquid crystal display unit, and a central processing unit,
wherein said display unit having a plurality of connectors;
wherein said display unit means a flat panel display unit; and
wherein said portable computer means having a plurality of signal input circuitry to toggle to receive a plurality of signals transmitted either from said central processing unit or said receiver device.
(b) said portable computer connecting to Internet means connecting said portable computer to Internet and accessing broadcasting station data center,
wherein accessing broadcasting data center means obtaining a plurality of broadcasting information, such as time, program names, and its broadcasting time length, for said television, and said radio programs.
